(19) United States
(12) Patent Application Publication
(10) Pub. No.: US 2009/0021746 A1
(43) Pub. Date: Jan. 22, 2009

(54) TOMOGRAPHY APPARATUS

(75) Inventors: Masahiro Toida, Kanagawa-ken (JP); Junji Nishigaki, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 11/814,063

(22) PCT Filed: Jan. 13, 2006
(86) PCT No.: PCT/JP2006/300792

§ 371 Date: Jul. 16, 2007

(30) Foreign Application Priority Data
Jan. 14, 2005 (JP) 2005-007651

(51) Int. Cl. G01B 9/02

(52) U.S. Cl. 356/484

(57) ABSTRACT

In a tomograpy apparatus: low-coherence laser light is split into measurement light and reference light; the frequency of the reference light is slightly shifted from the frequency of reflected light generated by reflection of the measurement light by a sample; the reference light is optically combined with the reflected light; interference light generated by interference of the reference light with the reflected light when the reference light is combined with the reflected light is detected: fluorescence emitted by excitation of a fluorescent dye or a fluorescent pigment in the sample when the sample is irradiated with the measurement light is detected: a first tomographic image of the sample is formed by the detected interference light, and a second tomographic image of the sample is formed by the detected fluorescence.

### TECHNICAL FIELD

The present invention relates to a tomography apparatus which acquires a tomographic image of a sample, for example, which is living tissue or cells.

### BACKGROUND ART

In observation of living tissue, morphology and (constituent) materials of cells constituting the living tissue are observed. in a known method for observing morphology and (constituent) materials of living tissue (in particular, living cells), cells of the living tissue are dyed with a fluorescent dye or the like for providing sufficient contrast, and thereafter the cells are observed by using an optical microscope (for example, as disclosed in Japanese Unexamined Patent Publication No. 2004-70371) Since most living cells or tissue is colorless and transparent/ and the difference in the refractive index between the inside and outside of the cells is small, it is impossible to make the contrast clear, so that it is difficult to observe such cells. Therefore, the dyeing with a fluorescent dye or the like is performed. The types of dyes used in the observations of the morphology of cells are different from the types of dyes used in the observations of the (constituent) materials, so that the morphology and (constituent) materials of cells are observed by detecting fluorescence having a plurality of wavelengths.

Alternatively, it is possible to use a phase-contrast microscope instead of the optical microscope (for example, as disclosed in Japanese Unexamined Patent Publication No. 2001-311875). In the phase-contrast microscope, colorless and transparent samples are visualized by the contrast produced by the diffraction and interference of light. Therefore, it is unnecessary to dye the samples.

However, in the case where observation is performed by use of a plurality of fluorescent dyes and the optical microscope as disclosed in Japanese Unexamined Patent Publication No. 2004-70371, an image formed by the fluorescence emitted from a fluorescent dye used for observation of the morphology and an image formed by the fluorescence emitted from a fluorescent dye used for observation of a (constituent) material are mixed, and such images formed by the fluorescence and an image formed by reflected light are also mixed. Therefore, it is not easy to distinguish each of the above images from the other images. In addition, in the case where the optical microscope is used, sliced samples of an object to be observed are prepared for observations. Nevertheless, since light scattering is enhanced in the objects which are basically constituted by living cells or tissue, it is difficult to acquire clear images by using the optical microscope.

Further, in the case where the phase-contrast microscope is used as disclosed in Japanese Unexamined Patent Publication No. 2001-311875, it is possible to observe only the morphology. However, the observation of (constituent) materials requires dyeing of samples with a fluorescent dye and use of the optical microscope. That is, it is necessary to observe morphology of a portion of undyed living tissue by use of a phase-contrast microscope, dye the living tissue with a fluorescent dye or the like, and observe the same portion of the living tissue by use of an optical microscope. Therefore, it takes much time and manpower to observe the morphology and (constituent) materials, and it is difficult to match the spatial coordinates of living tissue observed with the phase-contrast microscope with the spatial coordinates of living tissue observed with the optical microscope.

### DISCLOSURE OF THE INVENTION

The object of the present invention is to provide a tomography apparatus which can concurrently obtain a clear tomographic image of a sample formed by interference light and another clear tomographic image of the sample formed by fluorescence.

According to the present invention, there is provided a tomography apparatus for acquiring a tomographic image of a sample containing at least one of a fluorescent dye and a fluorescent pigment, comprising: a light-source unit which emits low-coherence laser light; an optical splitting unit which splits the low-coherence laser light into measurement light (light to be applied to the sample for measurement) and reference light; a frequency modulation unit which make a first frequency of the reference light slightly different from a second frequency of reflected light generated by reflection of the measurement light by the sample; an optical combining unit which optically combines the reference light with the reflected light; an interference-light detection unit which detects interference light generated by interference of the reference light with the reflected light when the reference light is combined by the optical combining unit with the reflected light, a fluorescence detection unit which detects fluorescence emitted by excitation of the fluorescent dye or the fluorescent pigment in the sample when the sample is irradiated with the measurement light; and an image acquisition unit which acquires a first tomographic image of the sample formed by the interference light detected by the interference-light detection unit, and a second tomographic image of the sample formed by the fluorescence detected by the fluorescence detection unit.

In the above tomography apparatus according to the present invention, the frequency modulation unit may shift either of the frequency of the reference light and the frequency of the reflected light so that the frequency of the reference light becomes slightly different from the frequency of the reflected light, and a beat signal the intensity of which varies at the frequency corresponding to the difference between the frequency of the reference light and the frequency of the reflected light is generated when the reference light and the reflected light are optically combined.

The sample may be any sample which contains a fluorescent dye or a fluorescent pigment. The sample may contain cells or the like which have an autofluorescent characteristic, or may be prepared boy dyeing an undyed sample with a fluorescent dye. In the case where the sample is dyed with a fluorescent dye, the fluorescent dye may be either a single-photon-excitation type or a two-photon-excitation

The light-source unit may be realized by any construction which emits low-coherence laser light capable of exciting the fluorescent dye or the fluorescent pigment in the sample. The low-coherence laser light may be ultrashort-pulse laser light. The ultrashort-pulse laser light is pulsed light having a width in the time domain on the order of picoseconds (ps) or smaller, and preferably on the order of feratoseconds (fs)

The light-source unit may comprise a laser-light source and an optical fiber. The laser-light source emits ultrashort-pulse laser light, and the optical fiber has a negative dispersion characteristic, and receives the ultrashort-pulse laser light emitted from the laser-light source. Alternatively, the light-source unit may be realized by a solid-state laser which emits ultrashort-pulse laser light.

The negative dispersion characteristic is that the wavelength dispersion decreases with increase in the wavelength. The wavelength dispersion is expressed in ps/nm/km. When pulsed light enters the above optical fiber, the pulse width of the pulsed light decreases during propagation through the optical fiber, and the pulsed light with the decreased pulse width is outputted from the optical fiber as the low-coherence laser light. The optical fiber having the negative dispersion characteristic is, for example, a zero-dispersion fiber or a photonic crystal fiber.

Although the wavelength of the laser light emitted from the light-source unit should be appropriately chosen according to the excitation wavelength of the fluorescent dye or the fluorescent pigment contained in the sample, it is preferable that the wavelength of the laser light is in the near-infrared wavelength range, i.e., in the range of 750 to 2,500 nm.

The tomography apparatus according to the present invention may comprise a microlens array which condenses the measurement light so that the measurement light converges in a plurality of regions in the sample. At this time, the optical combining unit optically combines the reference light with reflected light generated by reflection of the measurement light in each or the plurality or regions, the fluorescence detection unit detects fluorescence emitted from each of the plurality of regions, and the interference-light detection unit detects interference light generated by interference of the reference light with reflected light generated by reflection of the measurement light in each of the plurality of regions.

The tomography apparatus according to the present invention has the following advantages.
(a) When tomographic images of a sample containing at least one of a fluorescent dye and a fluorescent pigment are obtained by using the tomography apparatus according to the present invention, the image acquisition unit acquires the second tomographic image of the sample formed by the fluorescence detected by the fluorescence detection unit as well as the first tomographic image of the sample formed by the interference light detected by the interference-light detection unit. Hereinafter, tomographic images of a sample formed by the fluorescence detected as above are referred to as fluorescence tomographic images, and tomographic images of a sample formed by interference light detected as above are referred to as interference-light tomographic images or optical coherence tomographic (OCT) images. The interference-light tomographic image can be used for observation of the morphology of the sample, and the fluorescence tomographic image can be used for observation of a (constituent) material of the sample. That is, according to the present invention, the tomographic images for observations of the morphology and a (constituent) material of the sample can be concurrently obtained. Therefore, it is possible to efficiently perform observations of the morphology and the (constituent) material of the sample.
(b) In addition, since the observation of morphology can be performed without use of the optical microscope, which is conventionally used, it is possible to obtain clear interference-light tomographic images for observation of morphology of a sample, and perform in vivo observation of the sample, even when the sample is basically constituted by multiple cells or tissue in which light scattering is enhanced.
c) further, since an interference-light tomographic image and a fluorescence tomographic image are concurrently obtained, the spatial coordinates of the interference-light tomographic image can be matched with the spatial coordinates of the fluorescence tomographic image on every occasion. Therefore, it is possible to accurately analyze living tissue.
(d) In the case where the fluorescent dye is a two-photon-excitation type, and measurement of a deep region of a sample is performed, it is possible to realize fluorescent excitation in only the deep region of the sample, and a obtain clear fluorescence tomographic image of the deep region of the sample.
(e) In the case where light-source unit comprises a laser-light source realized by one of a mode-locked fiber laser and a mode-locked semiconductor laser which emit ultrashort-pulse laser light, and an optical fiber having a negative dispersion characteristic in a wavelength range to which the ultrashort-pulse laser light belongs, transmitting the ultrashort-pulse laser light emitted from the laser-light source, and outputting the low-coherence laser light, it is possible to obtain interference-light tomographic images with high resolution. In particular, in the case where the fluorescent dye is a two-photon-excitation type, it is possible to guarantee a laser intensity necessary for excitation of the fluorescent dye since the pulse width of the laser light emitted from the light-source unit is small. Thus, clear fluorescence tomographic images can be obtained.
(f) In the case where the light-source unit emits laser light having a wavelength belonging to the near-infrared wavelength range, the transmittance of the laser light through the sample can be increased. Therefore, it is possible to obtain interference-light tomographic images with the cell-level resolution without influence of the scattering in the sample even when the sample is basically constituted by, for example, multiple cells or tissue. In addition, since the transmittance of the laser light through the sample is increased, it is possible to cause fluorescent excitation in only a deep region of the sample, and obtain clear fluorescence tomographic images of the deep region.
   (g) In the case where the tomography apparatus comprises a microlens array which condenses the measurement light so that the measurement light converges in a plurality of regions in the sample, and the optical combining unit optically combines the reference light with reflected light generated by reflection of the measurement light in each of the plurality of regions, and the fluorescence detection unit detects fluorescence emitted from each of the plurality of regions, and the interference-light detection unit detects interference light generated by interference of the reference light with the reflected light generated by reflection of the measurement light in each of the plurality of regions, the plurality of regions can be concurrently scanned and irradiated with the measurement light. Therefore, it is possible to accurately perform observation of the sample even when the state Of the sample varies in a short time as in the case of living cells.

### BRIEF DESCRIPTION OF THE DRAWINGS

FIG. 1 is diagram schematically illustrating the construction of a tomography apparatus according to a first embodiment of the present invention.

FIG. 2 is a diagram schematically illustrating the construction of an example of a light-source unit in the tomography apparatus of FIG. 1.

FIGS. 3A to 3C are graphs indicating characteristics of an optical fiber used in the light-source unit of FIG. 2.

FIGS. 4A and 4B are graphs indicating characteristics of another optical fiber used in the light-source unit of FIG. 2.

FIG. 5 is a diagram schematically illustrating the construction of an example of a solid-state laser used in the light-source unit of FIG. 2.

FIG. 6 is a diagram schematically illustrating the construction of an example of a scanning stage on which a sample is placed in the tomography apparatus of FIG. 1.

FIG. 7A is an energy level diagram schematically illustrating the two-photon excitation.

FIG. 7B is a diagram schematically illustrating a region from which fluorescence is emitted by two-photon excitation.

FIG. 8A is an energy level diagram schematically illustrating the single-photon excitation.

FIG. 8B is a diagram schematically illustrating a region from which fluorescence is emitted by single-photon excitation.

FIG. 9 is a diagram schematically illustrating scanning (irradiation) of a cell in a sample with measurement light.

FIGS. 10A to 10E are graphs indicating examples of beat signals detected during the scan illustrated in FIG. 9.

FIG. 11 is a graph indicating the intensity of fluorescence detected during the scan illustrated in FIG. 9.

FIG. 12A is a diagram illustrating an example of an interference-light tomographic image.

FIG. 12B is a diagram illustrating an example of a fluorescence tomographic image.

FIG. 12C is a diagram illustrating an example of superimposed display of the interference-light tomographic image and the fluorescence tomographic image.

FIG. 13 is a diagram schematically illustrating the construction of a tomography apparatus according to a second embodiment of the present invention.

### BEST MODE FOR CARRYING OUT THE INVENTION

Preferred embodiments of the present invention are explained in detail below with reference to drawings.

Construction of First Embodiment

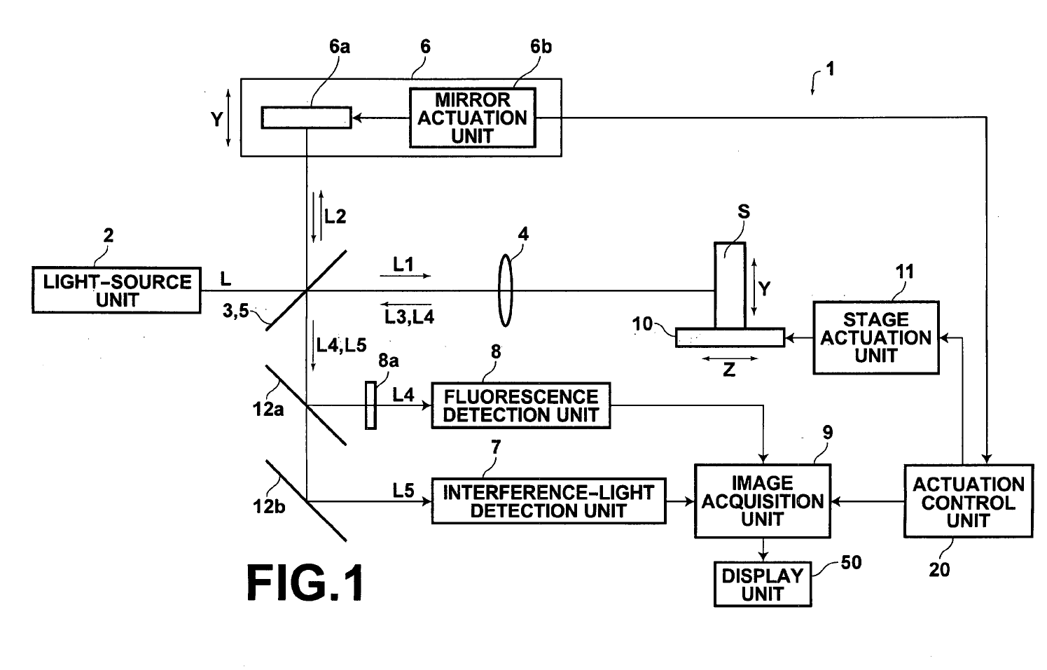

FIG. 1 is a diagram schematically illustrating the construction of a tomography apparatus according to the first embodiment of the present invention. The tomography apparatus 1 of FIG. 1 concurrently obtains an optical coherence tomographic (OCT) image (corresponding to the aforementioned interference-light tomographic image) and a fluorescence tomographic image, where the OCT image is obtained by OCT (optical coherence tomography) measurement, and the fluorescence tomographic image. The tomography apparatus 1 of FIG. 1 comprises a light-source unit 2, an optical splitting unit 3, a frequency modulation unit 6, an optical combining unit 5, an interference-light detection unit 7, a fluorescence detection unit 8, and an image acquisition unit 9.

The light-source unit 2 emits laser light L. The optical splitting unit 3 splits the laser light L into measurement light L1 and reference light L2. The measurement light L1 is applied to a sample S. The frequency modulation unit 6 produces a slight difference between the frequency of the reference light L2 and the frequency of reflected light L1 generated by reflection of the measurement light L1 by the sample S. The optical combining unit 5 optically combines the reference light L2 with the reflected light L3. The interference-light detection unit 7 detects interference light L5 generated by interference of the reference light L2 with the reflected light L3 when the reference light L2 is combined by the optical combining unit 5 with the reflected light L3. The fluorescence detection unit 8 detects fluorescence L4 which is emitted by excitation of the fluorescent dye or the fluorescent pigment in the sample S when the sample S is irradiated with the measurement light L1. The image acquisition unit 9 acquires an OCT image of the sample S formed by the interference light L5 detected by the interference-light detection unit 7, and a fluorescence tomographic image of the sample S formed by the fluorescence L4 detected by the fluorescence detection unit 8.

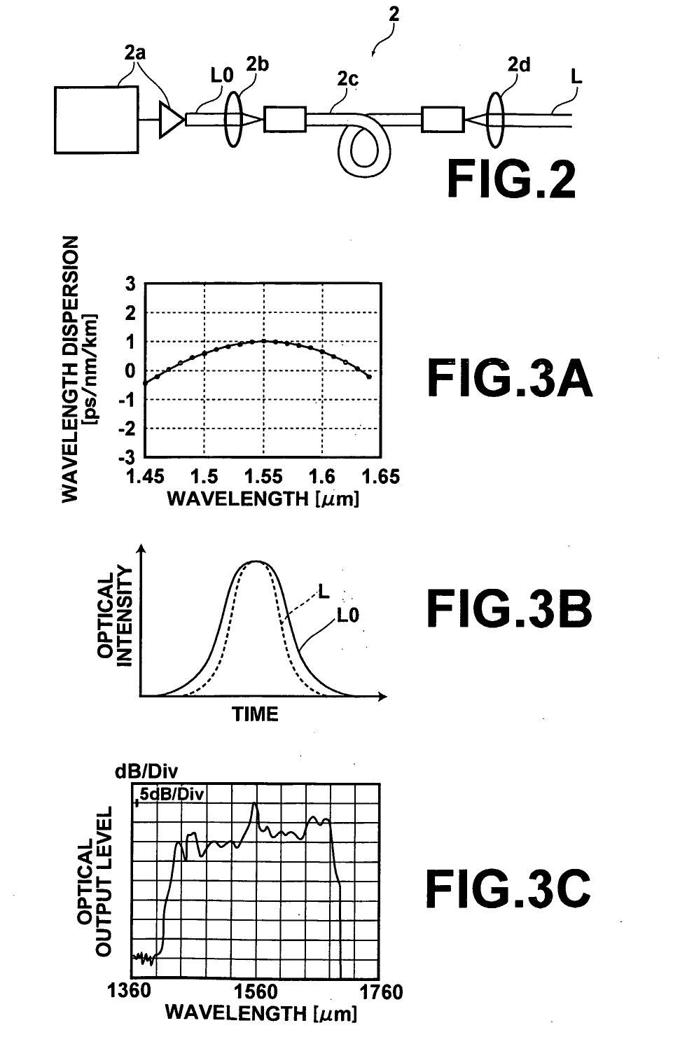

For example, the light-source unit 2 is realized by a supercontinuum light source. FIG. 2 shows the construction of an example of the light-source unit 2. The light-source unit 2 illustrated in FIG. 2 comprises a laser-light source 2a, a lens 2b, an optical fiber 2c, and a collimator lens 2d. The laser-light source 2a emits ultrashort-pulse laser light L0, the lens 2b is arranged so that the ultrashort-pulse laser light L0 emitted from the laser-light source 2a enters the optical fiber 2c through the lens 2b. The optical fiber 2c has a negative dispersion characteristic, and the collimator lens 2d is arranged so that the ultrashort-pulse laser light L outputted from the optical fiber 2c enters the optical splitting unit 3 through the collimator lens 2d.

For example, the laser-light source 2a is realized by a mode-locked fiber laser constituted by an Er-doped fiber laser and an Er optical amplifier, and emits low-coherence laser light having a pulse width of 145 fs (femtoseconds), a center wavelength of 1.555 micrometers, and a spectral bandwidth of approximately 18 nm. Details of the construction and the operational principle of the mode-locked fiber ring laser are indicated in M. Nakazawa et al., “Mode-locked Fiber Ring Lasers,” in Japanese (only the abstract is available in English), Review of Laser Engineering, Vol. 27, No. 11 (November 1999), pp. 756-761, The Laser Society of Japan. The content of this document are incorporated by reference in this description.

For example, the optical fiber 2c has a negative dispersion characteristic in a wavelength range around 1.56 micrometers as indicated in FIG. 3A. When the ultrashort-pulse laser light L0 propagates through the optical fiber 2c, the pulse width decreases and the spectral bandwidth increases. Specifically, In the case where the pulse width of the ultrashort-pulse laser light L0 is on the order of femtoseconds (fs), longer wavelength components of the pulse propagate faster than shorter wavelength components of the pulse by the self-phase modulation effect as indicated in FIG. 3B. Therefore, when the above ultrashort-pulse laser light propagates through the optical fiber 2c, which has the negative dispersion characteristic, the pulse width decreases. For example, in the case where the ultrashort-pulse laser light L0 is low-coherence laser light having a pulse width of 145 fs, a center wavelength of 1.555 micrometers, and a spectral bandwidth of approximately 18 nm as mentioned before, near-infrared laser light having a pulse width of 10 fs and a wide spectral bandwidth of approximately 800 nm (as indicated in FIG. 3C) is outputted as the laser light L from the optical fiber 2c.

As explained above, the pulse width and the coherent length can be decreased by making the pulsed laser light emitted from the laser-light source 2a propagate through the optical fiber 2c having the negative dispersion characteristic. Therefore, it is possible to obtain a high-resolution OCT image.

Alternatively, the light-source unit 2 may have the following construction.

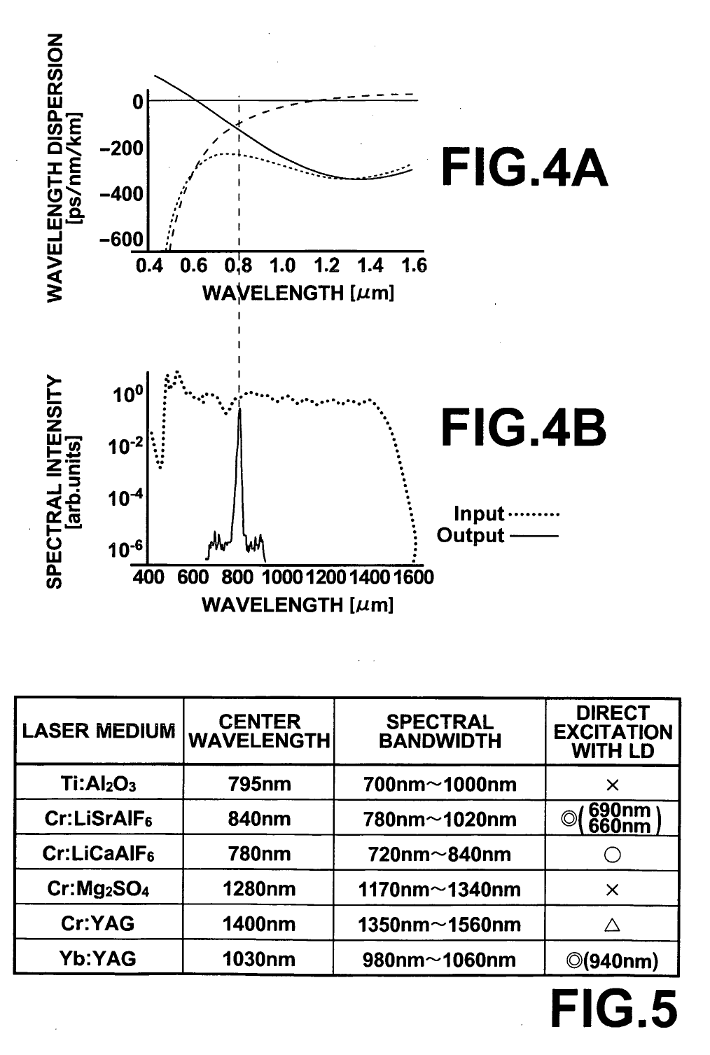

That is, the laser-light source 2a may be realized by a Ti:Al₂O₃ laser which emits laser light having a center wavelength of 795 micrometers and a spectral bandwidth of approximately 700 to 1,000 nm. At this time, the optical fiber 2c may be a photonic crystal fiber (PCF) having a negative dispersion characteristic in the wavelength range around 800 nm as indicated in FIG. 4A. In this case, near-infrared laser light as indicated in FIG. 4B is outputted as the laser light L from the optical fiber 2c.

Further, the laser-light source 2a may be realized by a Cr:LiSrAlF₆ laser, a Cr:LiCalF₆ laser, a Cr:Mg₆SO₄ laser, a Cr:YAG laser, a Yb:YAG laser, or the like (as indicated in FIG. 5) which emits short-pulse laser light in the near-infrared wavelength range having a wavelength of 800 to 1,300 nm and a pulse width on the order of picoseconds to subpicoseconds.

Although, in the above examples of the light-source unit 2, the laser-light source 2a and the optical fiber 2c are combined, alternatively, the laser light emitted from the laser-light source 2a may directly enter the optical splitting unit 3. Specifically, it is possible to directly input into the optical splitting unit 3 laser light emitted from one of the Cr:LiSrAlF₆ laser, the Cr:LiCaAlF₆ laser, and the Yb:YAG laser. Further, the light-source unit 2 may be realized by the constructions disclosed in Y. Cho, “Fundamentals of Mode-locked Technology,” in Japanese (only the abstract is available in English), Review of Laser Engineering, Vol. 27, No. 11 (November 1999), pp.735-743, and K. Torizuka, “Ultrashort Pulse Generation by Mode-locked Solid-state Lasers,” in Japanese (only the abstract is available in English), Review of Laser Engineering, Vol. 27, No. 11 (November 1999), pp. 744-749, The Laser Society of Japan. The contents of the above documents are incorporated by reference in this description.

The optical splitting unit 3 in the construction of FIG. 1 is realized by, for example, a beam splitter. The optical splitting unit 3 lets a first portion of the laser light L (emitted from the light-source unit 2) through the optical splitting unit 3 so that the first portion is applied to the sample S as the measurement light L1. At the same time, the optical splitting unit 3 reflects a second portion of the laser light L sc that the second portion enters the frequency modulation unit 6 as the reference light L2. In the construction of FIG. 1, the beam splitter also has the function of the optical combining unit 5, and optically combines the reflected light L3 with the reference light L2.

The frequency modulation unit 6 makes the frequency of the reference light L2 slightly different from the frequency of the reflected light L3. Specifically, the frequency modulation unit 6 in FIG. 1 comprises a reference mirror Ga and a mirror actuator 6b. The reference mirror 6a reflects the reference light L2 toward the optical combining unit 5, and the mirror actuator 6b makes the reference mirror 6a move in the direction perpendicular to the optical axis of the reference light L2 (i.e., the directions of the arrows Y indicated in FIG. 1). While the mirror actuator 6b is actuating the reference mirror 6a, the frequency of the reference light L2 is slightly shifted by the Doppler shift, and the reference light L2 the frequency of which is shifted by the frequency modulation unit 6 enters the optical combining unit 5. The operation of the mirror actuator 6b is controlled by an actuation control unit 20.

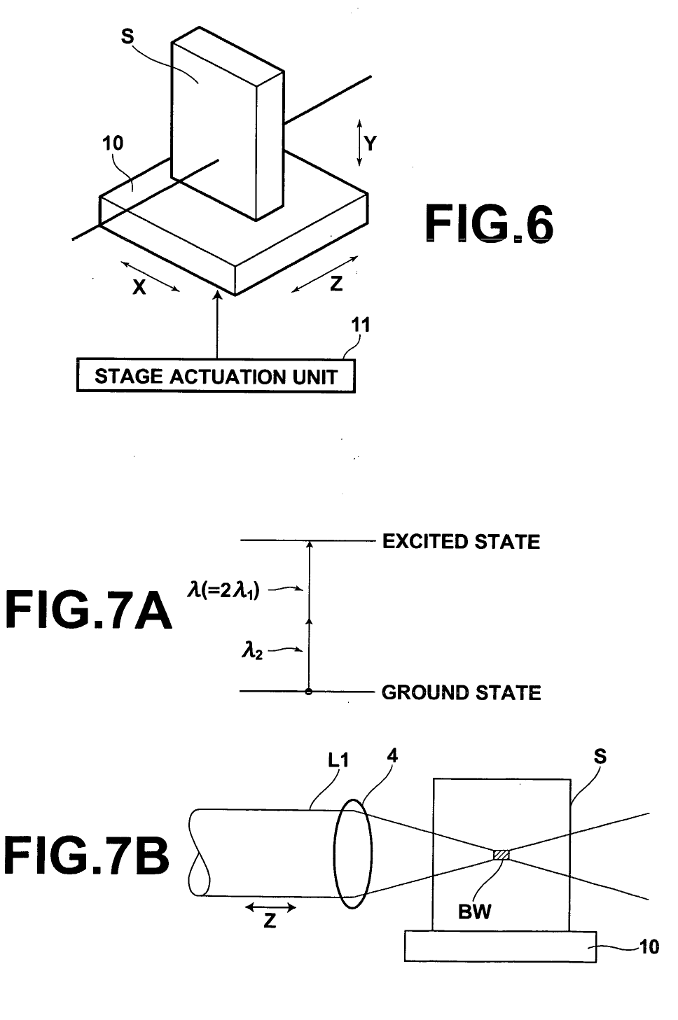

A condensing lens 4 is arranged between the optical splitting unit 3 and the sample S so that the measurement light L1 from the optical splitting unit 3 is converged by the condensing lens 4 and applied to the sample S. For example, the sample S is placed on a scanning stage 10 as illustrated in FIG. 6, and held in such a manner that sample S can be moved in the directions of the arrows X, Y, and Z by a stage actuation unit 11. The stage actuation unit 11 is controlled by the actuation control unit 20. The actuation control unit 20 controls the reference mirror ba and the stage actuation unit 11 so that the distance between the optical splitting unit 3 and the reference mirror 6a is equal to the distance between the optical splitting unit 3 and the focal point of the condensing lens 4. Thus, the reflected light L3 interferes with the reference light L2 at the optical combining unit 5, and the interference-light detection unit 7 detects a beat signal the intensity of which varies at the frequency corresponding to the difference between the frequency of the reference light L2 and the frequency of reflected light L3.

Although the focal point of the condensing lens 4, which is located in the sample S, is moved by moving the scanning stage 10 in the directions of the arrows Z in FIG. 6, alternatively, the location of the focal point in the sample S may be moved by moving the condensing lens 4 in the directions of the arrows Z.

The optical combining unit 5 is realized by the aforementioned beam splitter, which also has the function of the optical splitting unit 3. The optical combining unit 5 optically combines the reflected light L3 from the sample S, with the reference light L2 the frequency of which is shifted by the frequency modulation unit 6, and outputs the combined light toward the mirror 12b. In addition, the optical combining unit 5 reflects the fluorescence L4 emitted from the sample S, toward a dichroic mirror 12a.

The interference-light detection unit 7 is realized by, for example, a heterodyne interferometer or the like, and detects the intensity of the interference light L5. Specifically, when the optical path length between the optical splitting unit 3 and the reference mirror 6a is equal to the optical path length between the optical splitting unit 3 and the focal point of the condensing lens 4 the aforementioned beat signal the intensity of which varies at the frequency corresponding to the difference between the frequency of the reference light L2 and the frequency of reflected light L3 is generated. That is, the interference-light detection unit 7 detects the intensity of the beat signal.

The fluorescence detection unit 8 is realized by an image-taking unit such as a CCD camera, and detects the intensity of the fluorescence L4 which is emitted from the sample S and enters the fluorescence detection unit 8 through the optical combining unit 5, the dichroic mirror 12a, and a cut filter 8a. The fluorescence detection unit 8 may be configured to detect fluorescence in only a specific wavelength range, or to detect fluorescence in each of a plurality of wavelength ranges.

The image acquisition unit 9 concurrently obtains an OCT image formed by the interference light L5 detected by the interference-light detection unit 7, and a fluorescence tomographic image formed by the fluorescence L4 detected by the fluorescence detection unit 8. In addition, the image acquisition unit 9 has the function of displaying the OCT image and the fluorescence tomographic image on a display unit 50.

Fluorescent Dye

Hereinbelow, the fluorescent dye contained in the sample S is explained in detail.

The sample S may be dyed with a fluorescent dye, or contain cells or the like having an autofluorescent characteristic. In the case where the sample S is dyed with a fluorescent dye, it is preferable that the fluorescent dye is a two-photon-excitation type. In this case, fluorescence is emitted from substantially only at least one region of the sample S in each of which the measurement light L1 converges through the condensing lens 4. Details of the principle of the two-photon excitation process is explained in Y. Kawata, “Two-photon Microscopy for the observation of Internal Defects in Semiconductor Crystals in Three-dimensions,” in Japanese (only the abstract is available in English), Review of Laser Engineering, Vol. 31, No. 6 (June 2003), pp. 380-383, The Laser Society of Japan. The content of this document are incorporated by reference in this description.

That is, as illustrated in FIG. 7A, when a two-photon-excitation fluorescent dye concurrently absorbs two photons having a wavelength 2 corresponding to half of excitation energy in excitation from a ground state to an excited state, an electron in the ground state is excited to the excited state. Since the probability of occurrence of the two-photon excitation process is proportional to the square of the optical intensity, as illustrated in FIG. 1B, the fluorescence L4 is generated only in the vicinity of the beam waist (BW) of the measurement light L1, in which the measurement light L1 converges and the optical intensity is great. That is, the probability of occurrence of the two-photon excitation process in the sample S other than the beam waist (BW) of the measurement light L1 is very low. Therefore, even when the measurement light L1 converges in a deep region (in the directions of the arrows Z) of the sample S, it is possible to detect fluorescence emitted from the deep region since little of the measurement light L1 is absorbed on the way to the deep region.

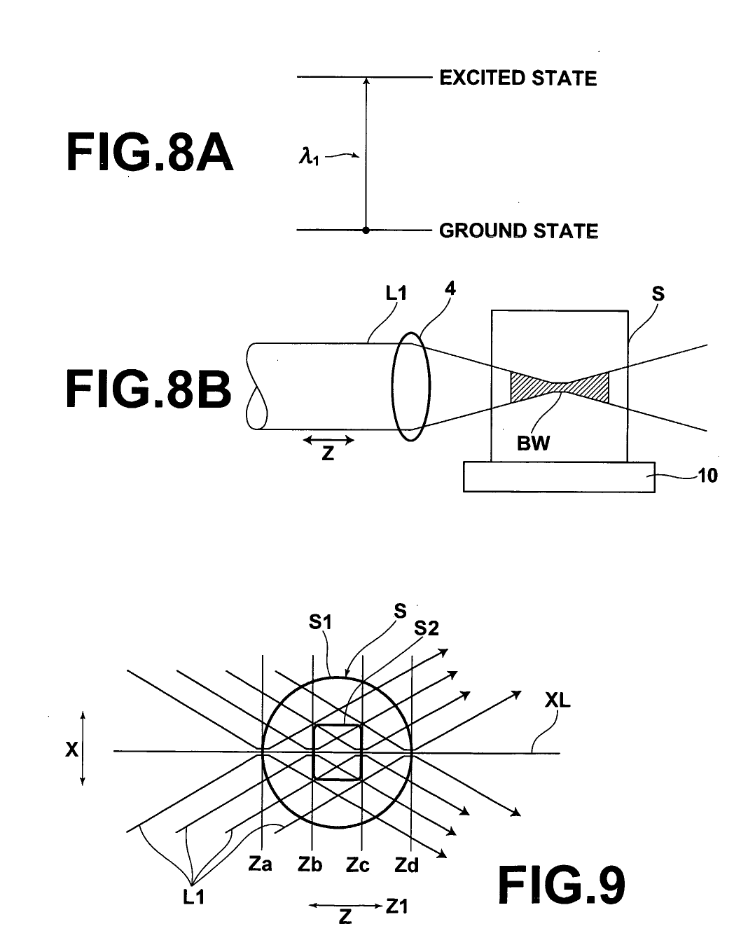

On the other hand, as illustrated in FIG. 8A, when a single-photon-excitation fluorescent dye absorbs a single photon having a wavelength λ1 corresponding to excitation energy in excitation from a ground state to an excited state, an electron in the ground state is excited to the excited state. If the aforementioned excitation energy corresponding to twice the energy of each photon having the wavelength λ2 in the two-photon excitation process is equal to the above excitation energy corresponding to the energy of the photon having the wavelength λ1 in the single-photon excitation process, the wavelength λ2 in the two-photon excitation process is twice the wavelength λ1 in the single-photon excitation process, i.e., 12=211. Therefore, as illustrated in FIG. 8B, the region in which the fluorescence L4 is generated in the single-photon excitation process includes the beam waist (BW) of the measurement light L1, and is greater than the region in which the fluorescence L4 is generated in the two-photon excitation process.

Since many of the pigments inherently contained in living tissue absorb visible light and emit fluorescence or the like, the visible light (as excitation light used in the single-photon excitation process) per se is strongly scattered, and fluorescence is emitted by the single-photon excitation process from almost the entire region of the sample through which the measurement light L1 passes as illustrated in FIG. 8B. For the above and some other reasons, it is difficult to observe deep regions of the sample by using the single-photon excitation process. On the other hand, in the case where the two-photon excitation process is used, the excitation light having the wavelength λ2, which is twice the wavelength λ1 of the excitation light (the visible light) used in the single-photon excitation process, is applied to the sample. For example, the wavelength λ2 of the excitation light used in the two-photon excitation process is in the near-infrared wavelength range of 800 to 1,300 nm. Therefore, the use of the two-photon excitation process improves the transmittance of the excitation light through the living tissue, and enables limiting the optical excitation to a deep region of the sample.

Further, in the case where the light-source unit 2 emits the ultrashort-pulse laser light having a wide bandwidth in the near-infrared wavelength range, for example, as indicated in FIGS. 2, 3A, 3B, 3C, 4A, 4B, and 5, it is possible to concurrently obtain a high-resolution OCT image and a clear fluorescence tomographic image as explained below.

First, a relationship between the light-source unit 2 and the OCT image is explained.

The coherent length of the light source determines the resolution of the OCT image of the sample S in the direction of the optical axis. Therefore, in order to increase the resolution, it is effective to broaden the spectral bandwidth of the light source. On the other hand, since the light spot size determines resolution in the lateral directions, high spatial coherence of the light source is required. That is, in order to improve both of the in-plane resolution and the resolution in the optical-axis direction, a light source having high spatial coherence and low time coherence (wide spectral bandwidth) is required. The ultrashort-pulse laser light emitted from the light-source unit 2 having a wide bandwidth in the near-infrared wavelength range satisfies the above requirement for improvement of both of the in-plane resolution and the resolution in the optical-axis direction, and enables acquisition of high-resolution OCT images.

Next, a relationship between the light-source unit 2 and the fluorescence tomographic image is explained.

In order to efficiently cause the two-photon excitation for obtaining the fluorescence tomographic image, it is necessary to increase the optical intensity. For this purpose, spatial and temporal concentration of the excitation light (i.e., convergence and reduction of the pulse width) is effective. Therefore, in the case where the fluorescent dye is a two-photon excitation type, and the light-source unit 2 emits ultrashort-pulse laser light L having a wide bandwidth in a near-infrared wavelength range, it is possible to obtain clear fluorescence tomographic images.

The type of the two-photon-excitation fluorescent dye is chosen so that a fluorescent reagent containing a fluorescent dye of the type is bound, in advance, to a material to be observed in the sample S, and the fluorescent characteristic of the fluorescent dye varies with the circumstances (e.g., an ion concentration such as pH). In particular, it is preferable to use a two-photon-excitation fluorescent dye which exhibits high efficiency in the two-photon excitation. Specifically, it is preferable that the two-photon-absorption cross section of the two-photon-excitation fluorescent dye is 10² GM or greater, where 1 GM is 1×10⁻⁵⁰ cm⁴ second/photon/molecule. For example, it is preferable to use the following two-photon-absorption compounds.

(i) The stilbazolium derivatives which are disclosed in He, G. S. et al., “Two-photon Pumped Cavity Lasing in Novel Dye Doped Bulk Matrix Rods,” Applied Physics Letters Vol. 67 (1995), Issue 25, pp. 3703-3705, He, G. S. et al., “Optical Limiting Effect in a Two-photon Absorption Dye Doped Solid Matrix,” Applied Physics Letters Vol. 67 (1995), Issue 17, pp. 2433-2435, He, G. S. et al., “Upconversion Dye-doped Polymer Fiber Laser,” Applied Physics Letters Vol. 68 (1996), Issue 25, pp. 3549-3551, and He, G. S. et al., “Studies of Two-photon Pumped Frequency-unconverted Lasing Properties of a New Dye Material,” Journal of Applied Physics Vol. 81 (1997), Issue 6, pp. 2529-2537, and the like

(ii) The compounds disclosed in Japanese Unexamined Patent Publication No. 2003-20469, pages 3 to 9 corresponding to U.S. Patent Application Publication No. 2003/0052311 A1, paragraphs Nos. 0027 to 0033 (pages 2 to 8)., and Japanese Unexamined Patent Publication No. 2003-183213, pages 5 to 17 corresponding to U.S. Patent Application Publication No. 2003/0162124 A1, paragraph No. 0058 (pages 5 to 24)

(iii) The compounds D-1 to D-35 disclosed in Japanese Unexamined Patent Publication No. 2004-123668, pages 8 to 11 corresponding to U.S. Patent Application Publication No. is 2004/0131969 A1, naragraph No. 0074 (pages 9 to 12)

In addition, the two-photon-absorption compounds disclosed in the above Japanese Unexamined Patent Publications Nos. 2003-20469, 2003-183213, and 2004-12368, and the above U.S. Patent Application Publications Nos. 2003/0052311 A1, 2003/0162124 A1, and 2004/0131969 A1 are particularly preferable as the two-photon-excitation

Further, it is preferable to introduce a reactive substituent which can be covalent-bonded, ion-bonded, or coordinate-bonded to a biomolecule, into each of the above preferable compounds. The reactive substituent is, for example, the succinimidyl ester group, the halogen-substituted triazinyl group, the halogen-substituted pyrimidinyl group, the sulfonyl halide group, the α-haloacetyl group, the maleimidyl group, the aziridinyl group, or the like. Furthermore, it is preferable to introduce a water-soluble group such as the sulfonic group (or a sultonic salt), the carboxyl group (or a carboxylic salt), the hydroxy group, or the polyether group. The above reactive substituent or water-soluble group can be introduced in any of the known manners.

As explained above, information on one or more functions of living cells or tissue is obtained by detecting fluorescence from a sample of the living cells or tissue after coupling a fluorescent reagent to a material to be observed, or using a reagent having a fluorescent characteristic which varies with variations in the circumstances (e.g., an ion concentration such as pH). Therefore, when a material which exhibits high efficiency in the two-photon excitation is used as the exogenous material (i.e., the fluorescent reagent), it is possible to produce images which indicate one or more functions of cells constituting a multicellular system or tissue, although the conventional techniques cause strong scattering in multicellular systems or tissue and make observation of the multicellular systems or tissue difficult.

Operation of First Embodiment

Hereinbelow, an example of the operation of the tomography apparatus 1 according to the first embodiment of the present invention is explained with reference to FIGS. 1 to 8.

First, the ultrashort-pulse laser light L0 emitted from the laser-light source 2a enters the optical fiber 2c, and the pulse width of the ultrashort-pulse laser light L0 is reduced during the propagation through the optical fiber 2c, so that the laser light L having the reduced pulse width is outputted from the optical fiber 2c through the collimator lens 2d to the optical splitting unit 3 as illustrated in FIG. 2. Thereafter, the laser light L is split by the optical splitting unit 3 into the measurement light L1 and the reference light L2, where the measurement light L1 is applied to the sample S through the condensing lens 4, and the reference light L2 enters the frequency modulation unit 6.

When the measurement light L1 is applied to the sample S, the reflected light L3 and the fluorescence L4 are emitted from the sample S, and enters the optical combining unit 5 through the condensing lens 4, where the reflected light L3 is generated by reflection of the measurement light L1 in the sample S, and the fluorescence L4 is generated by excitation of the fluorescent dye (or fluorescent pigment) in the sample S by the measurement light L1. On the other hand, the frequency of the reference light L2 is shifted by the frequency modulation unit 6, and then the reference light L2 enters the optical combining unit 5.

In the optical combining unit 5, the reflected light L3 is optically combined with the reference light L2 which is outputted from the frequency modulation unit 6, and the interference light L5 generated by interference of the reference light L2 with the reflected light L3 enters the interference-light detection unit 7 through the dichroic mirror 12a and the mirror 12b. On the other hand, the fluorescence L4 is reflected by the dichroic mirror 12a, and enters the fluorescence detection unit 8. Then, the image acquisition unit 9 acquires an OCT image formed by the interference light L5 detected by the interference-light detection unit 7, and a fluorescence tomographic image formed by the fluorescence L4 detected by the fluorescence detection unit 8.

Further, the sample S is moved while the sample S is irradiated with the measurement light L1. During the irradiation, the fluorescence L4 from each portion of the sample S is detected by the interference-light detection unit 7, the interference light L5 corresponding to (generated on the basis of the reflected light L3 from) each portion of the sample S is detected by the fluorescence detection unit 8, an OCT image is generated on the basis of the interference light L5 corresponding to the respective portions of the sample S, and a fluorescence tomographic image is generated on the basis of the fluorescene L4 from the respective portions of the sample S.

The operation of the image acquisition unit 9 is explained in detail below with reference to FIGS. 9 to 11.

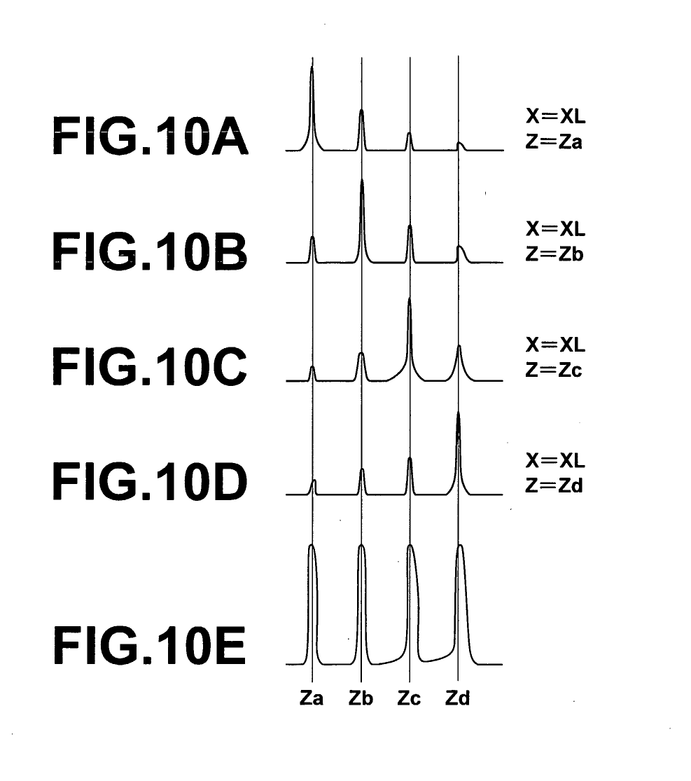

FIG. 9 is a diagram schematically illustrating scanning (irradiation) of a cell in a sample of a multicellular system or living tissue with measurement light L1 for obtaining a tomographic image of the cell in an X-Z cross section. In the example of FIG. 9, it is assumed that the cell membrane S1 of the cell in the sample S is dyed with a two-photon-excitation fluorescent dye. In addition, FIGS. 10A to 10E are graphs indicating examples of beat signals. detected during the scan illustrated in FIG. 9.

When the measurement light L1 converges at a first portion of the cell membrane S1 (at the coordinates X=XL and Z=Za), first reflected light is generated (as the reflected light L3) on the first portion of the cell membrane S1 since a gap of the refractive index exists at the cell membrane S1. Therefore, a beat signal having the intensity as indicated in FIG. 10A is detected by the interference-light detection unit 7. At this time, other reflected light is also generated on first and second (opposite) sides of the nucleus S2 (at the coordinates Z=Zb and Z=Zc) and on a second portion (opposite to the first portion) of the cell membrane S1 (at the coordinate Z=Zd). However, the optical path length of the first reflected light from the first portion of the cell membrane S1 is different from the optical path lengths of the other reflected light from the first and second sides of the nucleus S2 and the second portion of the cell membrane S1, and the reference mirror 6a is located at such a position that the first reflected light is stronger than the other reflected light.

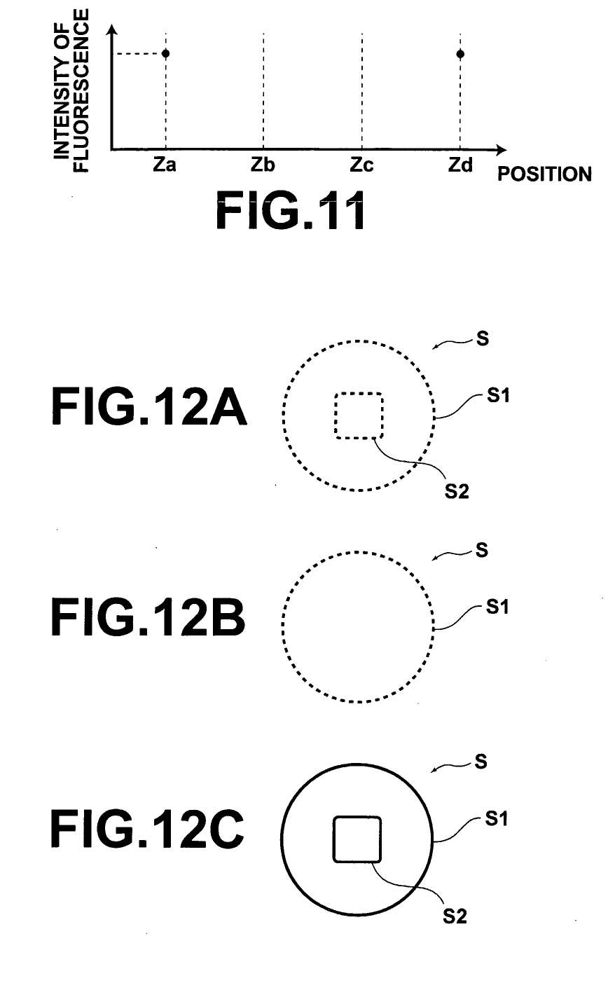

In addition, since the cell membrane S1 is dyed with the two-photon-excitation fluorescent dye, fluorescence (as the aforementioned fluorescence L4) is emitted from the position at which the measurement light L1 converges. Thus, the fluorescence detection unit 8 detects fluorescence emitted from the position at the coordinate Z=Za (the first portion of the cell membrane S1) as indicated in FIG. 11, which shows the intensity of fluorescence detected during the scan illustrated in FIG. 9.

Next, the position at which the measurement light L1 converges (corresponding to the aforementioned beam waist BW) moves in the direction of the arrow Z1, and reaches the first side of the nucleus S2 (at the coordinate Z=Zb), second reflected light is generated (as the reflected light L3) at the first side of the nucleus S2 since a gap of the refractive index exists at the boundary of the nucleus S2. At this time, the interference-light detection unit 7 detects a beat signal having the intensity as indicated in FIG. 10B. However, since the nucleus S2 is not dyed with the two-photon-excitation fluorescent dye, no fluorescence from the first side of the nucleus S2 (at the coordinate Z=Zb) is detected as indicated in FIG. 11.

Then, the position at which the measurement light L1 converges (corresponding to the beam waist BW) further moves in the direction of thearrow Z1, and reaches the second side of the nucleus S2 (at the coordinate Z=Zc), third reflected light is generated (as the reflected light L3) at the second side of the nucleus S2, and the interference-light detection unit 7 detects a beat signal having the intensity as indicated in FIG. 10C. However, since the nucleus S2 is not dyed with the two-photon-excitation fluorescent dye, no fluorescence from the second side of the nucleus S2 (at the coordinate Z=Zc) is detected as indicated in FIG. 11.

Thereafter, the position at which the measurement light L1 converges (corresponding to the beam waist BW) further moves in the direction of the arrow Z1, and reaches the second portion of the cell membrane S1 (at the coordinate Z=Zd), fourth reflected light is generated (as the reflected light L3) at the second portion of the cell membrane S1, and the interference-light detection unit 7 detects a beat signal having the intensity as indicated in FIG. 10D. At this time, fluorescence (as the aforementioned fluorescence L4) is emitted from the second portion of the cell membrane S1 since the cell membrane S1 is dyed with the two-photon-excitation fluorescent dye. The fluorescence detection unit 8 detects the fluorescence L4 from the second portion of the cell membrane S1 as indicated in FIG. 11.

Further, the image acquisition unit 9 calculates the average of the intensities of the beat signals of FIGS. 10A to 10D, as indicated in FIG. 10E. Thus, the intensity of the beat signal during the scan of the sample S with the measurement light L1 in the direction of the arrow Z1 along the line in which X=XL is obtained.

The above detection of the fluorescence L4 and the interference light L5 during the scan of the sample S with the measurement light L1 in the direction of the arrow Z1 is repeated while the sample S is moved along the directions of the arrows X. Thus, the image acquisition unit 9 obtains the intensity of the interference light L5 detected by the interference-light detection unit 7 at each position at which the measurement light L1 converges, in correspondence with the values of the X and Z coordinates indicating the position at which the measurement light L1 converges, so that an OCT image along an X-Z plane is generated as illustrated in FIG. 12A, which shows an example of an OCT image. At the same time, the image acquisition unit 9 also obtains the intensity of the fluorescence L4 detected by the fluorescence detection unit 8 at each position at which the measurement light L1 converges, in correspondence with the values of the X and Z coordinates indicating the position at which the measurement light L1 converges, so that a fluorescence tomographic image along the X-Z plane is generated as in illustrated FIG. 12B, which shows an example of a fluorescence tomographic image.

It is possible to display the OCT image as illustrated in FIG. 12A and the fluorescence tomographic image as illustrated in FIG. 12B side by side on the display unit 50. Alternatively, the OCT image and the fluorescence tomographic image may be displayed in a superimposed manner as illustrated in FIG. 12C, which shows an example of superimposed display of the OCT image and the fluorescence tomographic image.

As explained above, it is possible to concurrently obtain an OCT image for observation of morphology of a sample S and a fluorescence tomographic image for observation of a (constituent) material of the sample S. Therefore, the observation of the morphology and the (constituent) material of the sample S can be performed efficiently. In addition, the morphology can be observed without use of the optical microscope, which is conventionally used. Therefore, even in the case where the sample S is a multicellular system or tissue, it is possible to obtain clear OCT images for observation of morphology, and perform in vivo observation of the sample S. Further, since the spatial coordinates of the OCT image can be matched with the spatial coordinates of the fluorescence tomographic image on every occasion, it is possible to perform high-precision analysis of living tissue.

Construction of Second Embodiment

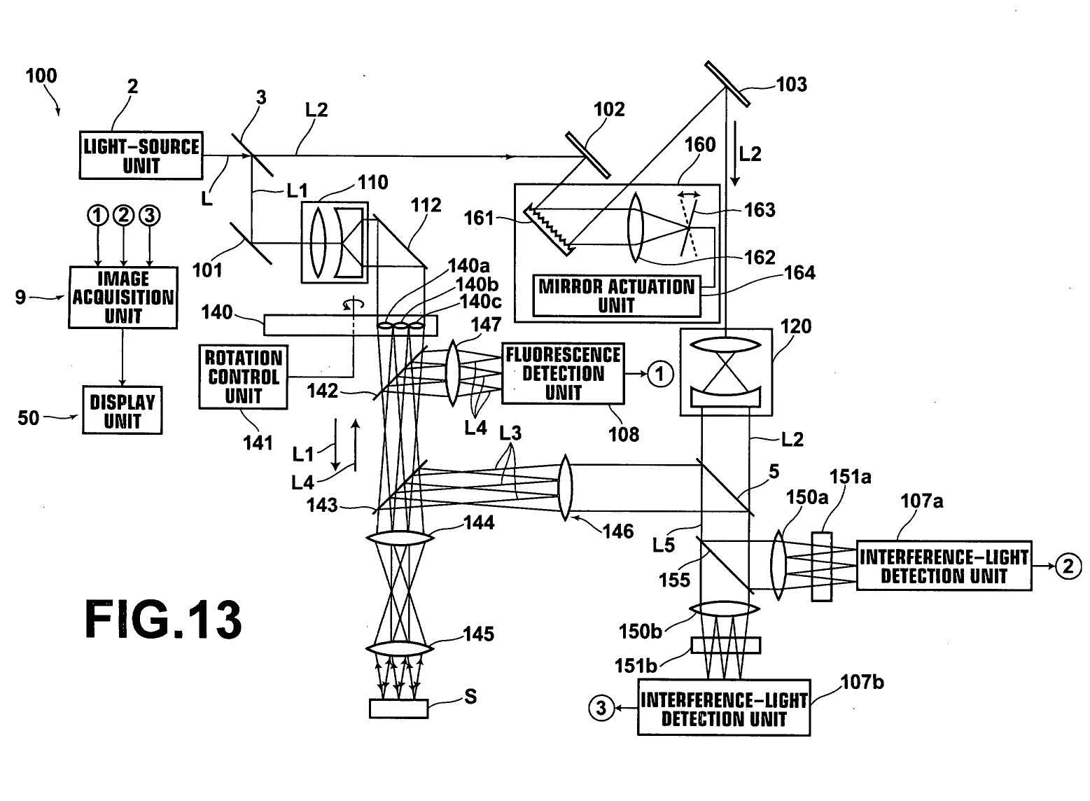

Hereinbelow, a tomography apparatus according to the second embodiment of the present invention is explained with reference to FIG. 13, which is a diagram schematically illustrating the construction of the tomography apparatus according to the second embodiment. In FIG. 13, elements and constituents which are equivalent to some elements or constituents in FIG. 1 are respectively indicated by the same reference numbers as FIG. 1, and descriptions of the equivalent elements or constituents are not repeated in the following explanations unless necessary.

The tomography apparatus 100 of FIG. 13 is different from the tomography apparatus 1 of FIG. 1 in that multibeam scanning is performed for applying the measurement light L1 to the sample S. Details of the multibeam scanning technique is explained in O. Nakamura et al., “Realtime Nonlinear-Optical Microscopy for Observing Biological Cells,” in Japanese (only the abstract is available in English), Review of Laser Engineering, Vol. 31, No. 6 (June 2003), pp. 371-374, and Japanese Unexamined Patent Publications Nos. 2000-193889.

Specifically, in the multibeam scanning, a microlens-array disk 140 is used for condensing measurement light L1, which is applied to the sample S. The microlens-array disk 140 has a structure in which a plurality of condensing lenses 140a, 140b, and 140c are arrayed, and is arranged to be rotated under control of a rotation control unit 141 in such a manner that the inside of the sample S can be scanned with the beam waist (BW) of the measurement light L1 when the microlens-array disk 140 is rotated. In order that the measurement light L1 enters the plurality of condensing lenses 140a, 140b, and 140c, the measurement light L1, which is outputted from the optical splitting unit 3, is reflected by a mirror 101, and enters a magnification lens group 110, which is provided for increasing the beam diameter of the measurement light L1. The measurement light L1 magnified by the magnification lens group 110 enters the microlens-array disk 140, and is transformed into a plurality of beams which converge at a plurality of positions in the sample S.

The plurality of beams of the measurement light L1 are applied to the sample S through a relay lens 144 and an objective lens 145. Then, reflected light L3 and fluorescence L4 are generated at each of the plurality of positions in the sample S. The reflected light L3 enters the optical combining unit 5 (realized by a beam splitter) through the objective lens 145, the relay lens 144, a beam splitter 143, and a collimator lens 146, and the fluorescence L4 enters a fluorescence detection unit 108 through the objective lens 145, the relay lens 144, the beam splitter 142, and an image-forming lens 147. The fluorescence detection unit 108 has a function of concurrently detecting the fluorescence L4 from the plurality of positions in the sample S.

On the other hand, reference light L2, which is outputted from the optical splitting unit 3, enters a frequency modulation unit 160 through a mirror 102. The frequency modulation unit 160 comprises a diffraction grating 161, a Fourier-transformation lens 162, a reference mirror 163, and the like. The reference mirror 163 is arranged so as to swing under control of a mirror actuation unit 164 . The reference light L2 is incident on the reference mirror 163 through the diffraction grating 161 and the Fourier-transformation lens 162, is reflected by the reference mirror 163, enters the diffraction grating 161 through the Fourier-transformation lens 162, and is thereafter incident on a mirror 103. Since the position in the diffraction grating 161 on which the reference light L2 from the reference mirror 163 is incident moves in correspondence with change in the inclination of the reference mirror 163, the frequency of the reference light L2 is shifted by the Doppler shift.

The reference Light L2 the frequency or which is shifted by the frequency modulation unit 160 is magnified by a pulse-width reduction unit 120, which has functions of beam magnification and dynamic focusing. After the reference light L2 is magnified by the pulse-width reduction unit 120, the reference light L2 enters the optical combining unit 5. The optical combining unit 5 optically combines the reference light L2 with the reflected light L3 generated at each of the plurality of positions in the sample S, so that interference light L5 is generated by interference of the reference light L2 with the reflected light L3. A beam splitter 155 optically splits the interference light L5 into first and second portions. The first portion of the interference light L5 enters an interference-light detection unit 107a through a lens 150a and a shutter 151a, and the second portion of the interference light L5 enters an interference-light detection unit 107b through a lens 105b and a shutter 151b. Both the interference-light detection units 107a and 107b has a function of detecting the intensity of the interference light L5.

It is possible to make the interference-light detection units 107a and 107b alternately detect the intensity of the interference light L5 by alternately opening the shutters 151a and 151b. In this case, the intensity of the interference light L5 can be detected at a pace corresponding to the speed of the scanning with the reference light L2. Further, the fluorescence detection unit 108 can concurrently detect the fluorescence L4 emitted from the plurality of positions in the sample S.

The image acquisition unit 9 in FIG. 13 acquires an OCT image formed by the interference light L5 detected by the interference-light detection units 107a and 107b, and a fluorescence tomographic image formed by the fluorescence L4 detected by the fluorescence detection unit 108.

The rotation control unit 141 and the mirror actuation unit 164 are controlled by an actuation control unit, which is not shown. The image acquisition unit 9 acquires from the actuation control unit information on the positions of the sample S to which the reference light L2 is applied.

In the case where the tomography apparatus 100 which performs the multibeam scanning as explained above is used, it is possible to scan the sample S with the measurement light L1 at high speed. Therefore, even in the case where the sample S contains living cells the states of which vary in a short time, it is possible to accurately observe such cells. In addition, since an OCT image for observation of morphology of the sample and a fluorescence tomographic image for observation of a (constituent) material of the sample can be obtained concurrently, it is possible to efficiently perform observations of the morphology and the (constituent) material.

Variations

The present invention is not limited to the above embodiments, and various variations can be considered within the scope of the present invention. For example, in the second embodiment, the frequency of the reference light L2 may be shifted by using an optical modulator or the like, instead of the reference mirror 163 and the diffraction grating 161. Further, in the first and second embodiments, the frequency modulation unit 6 may shift the frequency of the reflected light L3 instead of the reference light L2. For example, the frequency modulation unit 6 may be arranged to vibrate the sample S per se, and realize the frequency modulation by the Doppler shift caused by the vibration of the sample S.

1. A tomography apparatus for acquiring a tomographic image of a sample containing at least one of a fluorescent dye and a fluorescent pigment, comprising:
a light-source unit which emits low-coherence laser light;
an optical splitting unit which splits said low-coherence laser light into measurement light and reference light;
a frequency modulation unit which make a first frequency of said reference light slightly different from a second frequency of reflected light generated by reflection of said measurement light by said sample;
an optical combining unit which optically combines said reference light with said reflected light;
an interference-light detection unit which detects interference light generated by interference of said reference light with said reflected light when the reference light is combined by said optical combining unit with the reflected light;
a fluorescence detection unit which detects fluorescence emitted by excitation of said fluorescent dye said sample when the sample is irradiated with said measurement light; and
an image acquisition unit which acquires a first tomographic image of said sample formed by said interference light detected by said interference-light detection unit, and a second tomographic image of the sample formed by said fluorescence detected by said fluorescence detection unit.

2. a tomography apparatus according to claim 1, wherein said fluorescent dye is a two-photon-excitation fluorescent dye.

3. A tomography apparatus according to claim 1, wherein said light-source unit includes,
a laser-light source realized by one of a mode-locked fiber laser and a mode-locked semiconductor laser which emit ultrashort-pulse laser light, and
an optical fiber having a negative dispersion characteristic in a wavelength range to which said ultrashort-pulse laser light emitted from said laser-light source belongs, transmitting the ultrashort-pulse laser light, and outputting said low-coherence laser light.

4. A tomography apparatus according to claim 1, wherein said light-source unit is realized by a solid-state laser which emits ultrashort-pulse laser light.

5. A tomography apparatus according to claim 1, wherein said low-coherence laser light emitted from said light-source unit has a wavelength belonging to a near-infrared wavelength range.

6. A tomography apparatus according to claim 1, further comprising a microlens array which condenses said measurement light so that the measurement light converges in a plurality of regions in said sample wherein said optical combining unit optically combines said reference light with reflected light generated by reflection of said measurement light in each of the plurality of regions, said fluorescence detection unit detects fluorescence emitted from each of said plurality of regions, and said interference-light detection unit detects interference light generated by interference of said reference light with reflected light generated by reflection of said measurement light in each of said plurality of regions.
